(19) United States
(12) Patent Application Publication
(10) Pub. No.: US 2008/0295912 A1
(43) Pub. Date: Dec. 4, 2008

(54) BEND STIFFENER

(75) Inventor: Paul Louvain-Walters, Lancashire (GB)

Correspondence Address: BLAKELY SOKOLOFF TAYLOR & ZAFMAN LLP, 1279 OAKMEAD PARKWAY, SUNNYVALE, CA, 94085-4040, US

(73) Assignee: TRELLEBORG CRP LIMITED, Lancashire (GB)

(21) Appl. No.: 12/127,762

(22) Filed: May 27, 2008

(30) Foreign Application Priority Data
Jun. 4, 2007 (GB) 0710615.6

(51) Int. Cl. F16L 1/24

(52) U.S. Cl. 138/172; 138/108

(57) ABSTRACT

A bend stiffener 30 is disclosed which serves to resist excessive bending of an elongate underwater member 32, such as a cable, in a region where it meets a supporting structure such as an oil rig or buoy. The bend stiffener has a stiffener body 36 which defines a through-going channel for receiving and embracing the elongate member. A connection part 42, which may for example be formed as a tube, is shaped and positioned to enable it to be engaged with some complementary feature of the supporting structure (e.g. an upright I-tube) by upward movement of the bend stiffener. When thus engaged, the connection part serves to locate the stiffener body laterally and angularly. In accordance with the present invention, the bend stiffener is positively buoyant so that, once the connection part is engaged with the supporting structure, the bend stiffener's buoyancy suffices to maintain it in engagement.

### CROSS REFERENCE TO OTHER APPLICATIONS

The present patent application claims priority from United Kingdom Patent Application No. 0710651.6 filed on Jun. 4, 2007.

### BACKGROUND OF THE INVENTION

The present invention relates to bend stiffeners for underwater use.

There are many situations in which it is necessary to connect an elongate and moveable member to some underwater structure. One example of such a situation is illustrated in FIG. 1 and arises in connection with wave powered electricity generation. The means used for converting wave energy to electrical energy are not directly relevant for present purposes and are indicated only in a highly schematic form, but comprise a power buoy 10 mounted upon a tethered column 12 and able to move up and down it under the influence of waves on the sea 14. The vertical motion of the power buoy 10 relative to the column 12 is used to generate an electromotive force, and an electric power cable 16 depends from the base part of the column structure 12 and leads to a transformer 18 mounted on the sea bed. Floats 20 carried upon the power cable support at least part of its weight and the cable is able to move under the influence of tidal currents etc.

There is the potential risk that such motion will place undue bending loads upon the cable in the region where it emerges from the structure carried upon the column 12, which could cause local kinking in this region, or otherwise result in damage to, or failure of, the cable. To provide the cable with local protection in this area, it is known to fit it with a bend stiffener. Typically, known bend stiffeners comprise an elongate frusto-conical sleeve placed around the cable, the root of the sleeve being rigidly mounted upon the adjacent structure. The sleeve is typically capable of some degree of flexure, and due to its shape becomes less stiff from the root toward its tip. It serves to limit the radius of curvature of the cable in the vicinity of its junction with the adjacent structure and so to prevent excessively tight curvature or kinking.

It must be clearly understood that bend stiffeners are used not only in connection with cables as such, but with numerous other elongate underwater members including risers used in oil extraction, and the present invention is potentially applicable in a correspondingly broad range of different applications.

The applicant's published UK patent application 0503683.5 (publication number 2411445) discloses a bend stiffener which is intended to be particularly straightforward to install. It uses separate means for (a) carrying the bending and twisting moments applied to the bend stiffener by the cable or other elongate member in use and (b) locating the bend stiffener axially relative to a fixed I-tube on which it is mounted. The first of these functions is achieved by means of a cylinder which is received as a sliding fit in the I-tube. The second is achieved using a collar arrangement which limits axial movement of the cylinder—and of the bend stiffener which it carries—relative to the I-tube. The collar arrangement is sufficiently straightforward to engage/disengage that mounting of the bend stiffener can be carried out by a remotely operated vehicle, without need of a diver.

It is nonetheless desired to still further facilitate the process of mounting and de-mounting a bend stiffener. In the example application provided above—wave power generation—the bend stiffener assembly may need to be disassembled at various stages of the lifetime of the installation, and it is desirable to provide for this in a highly straightforward manner, preferably again without need of divers or other such intervention. Additionally or alternatively it is desired to provide a bend stiffener which is simple and/or robust.

### SUMMARY OF THE INVENTION

In accordance with the present invention, there is a bend stiffener for resisting excessive bending of an elongate underwater member in a region where it meets a supporting structure, the bend stiffener comprising a stiffener body defining a through-going channel for receiving and embracing the elongate member, and a connection part shaped and positioned to enable it to be engaged with a complementary feature of the supporting structure by upward movement of the bend stiffener, to locate the stiffener body laterally and angularly, the bend stiffener being positively buoyant so that, once the connection member or socket is engaged with the supporting structure, the bend stiffeners buoyancy suffices to maintain it in engagement.

The preferred means for providing engagement between the bend stiffener and the supporting structure is a projecting elongate member which may for example be cylindrical. This can for example be inserted upwardly into the downwardly open mouth of a conventional I-tube. Other alternatives could in principle be adopted, however, and in particular a socket could for example be formed as a bore in the stiffener body or some other component of the bend stiffener, to receive and locate upon a complimentary downwardly projecting member mounted on the supporting structure.

The supporting structure may of course take any number of forms but the power buoy 10 of FIG. 1 provides one example. A fixed or floating rig, such as an oil rig, is another.

The preferred materials for the stiffener body itself are typically either approximately neutrally buoyant or denser, and to render the bend stiffener as a whole positively buoyant it is preferred to attach at least one float to the stiffener body. Attachment of the float may for example be made by means of at least one tension band. Preferably the bend stiffener comprises at least two floats assembled to one another around the stiffener body.

The stiffener body itself may have a conventional shape with a relatively broad root end, coupled to the connection member, and a narrower and more flexible portion beneath the root end.

Preferably no mechanical means is provided for restraining downward movement of the bend stiffener relative to the supporting structure. Its buoyancy provides this function and maintains it in position relative to the supporting structure.

### BRIEF DESCRIPTION OF THE DRAWINGS

A specific embodiment of the present invention will now be described, by way of example only, with reference to the accompanying drawings in which:—

FIG. 1 is a highly schematic representation of an arrangement used for wave-driven power generation;

FIG. 2 is a view along a radial direction fan arrangement incorporating a bend stiffener embodying the present invention, one of a pair of semi-circular floats forming part of the bend stiffener being omitted to reveal certain internal detail;

FIG. 3 is a perspective illustration of the same arrangement, the float again being omitted;

FIG. 4 is a perspective illustration of the arrangement including both floats;

FIG. 5 is a scrap view showing detail of a flange and of the aforementioned float; and

FIG. 6 is a schematic representation of the same arrangement showing how it engages with a fixed I-tube.

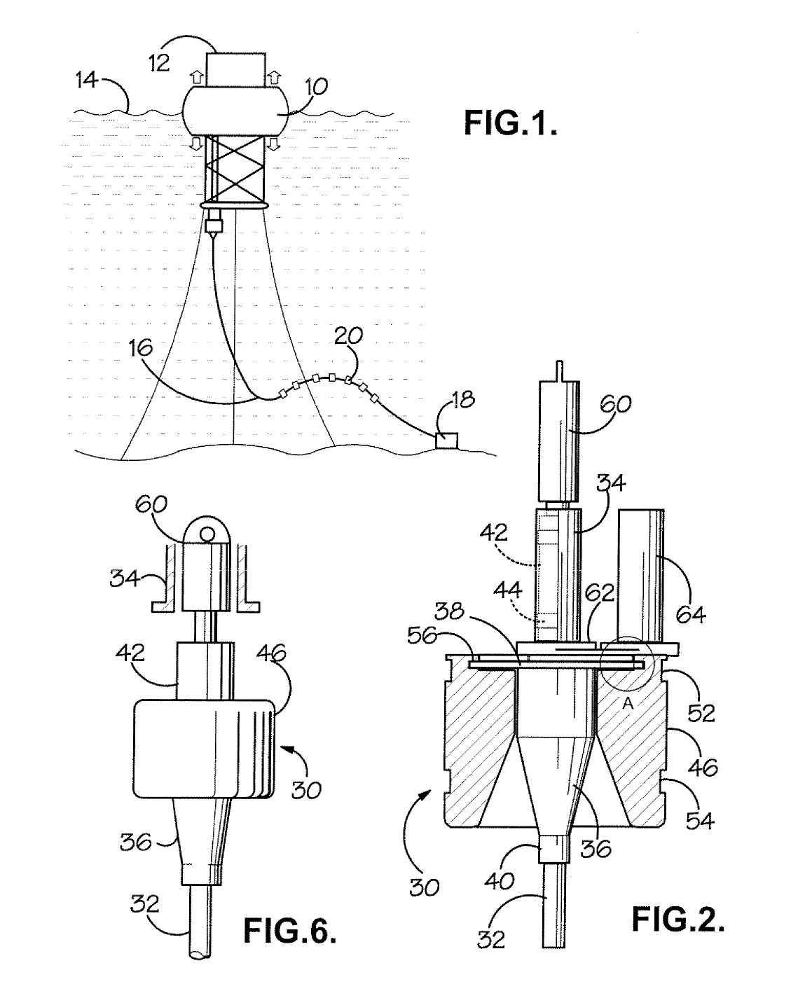

### DETAILED DESCRIPTION OF THE DRAWINGS

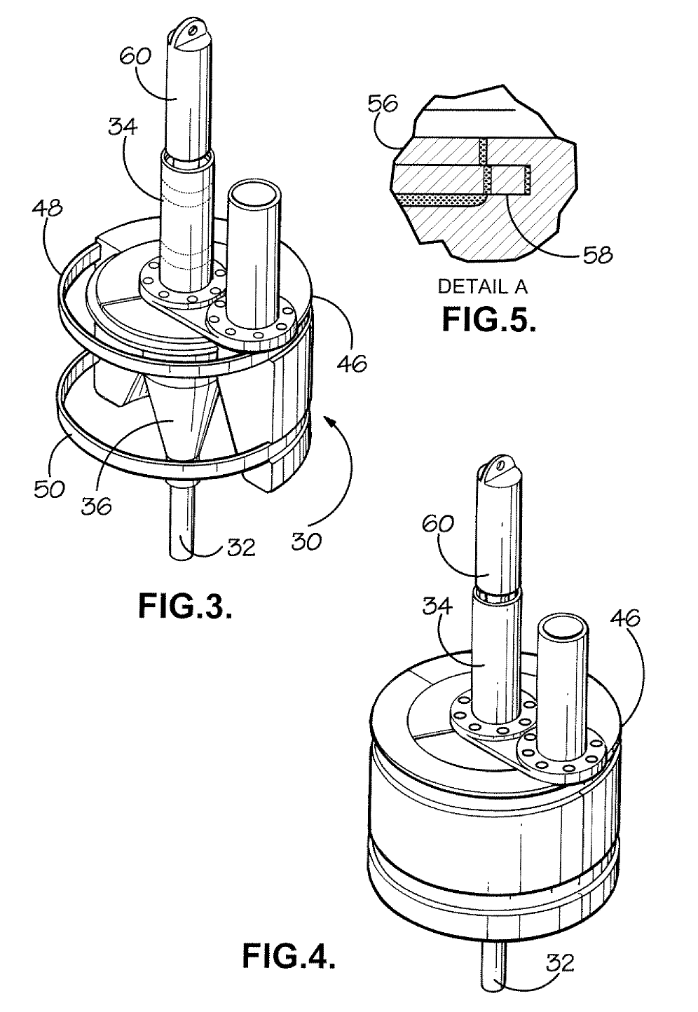

In the arrangement of FIGS. 2-6, a bend stiffener 30 serves to prevent excessive local bending or kinking of an umbilical/cable 32 in the region where it emerges from an I-tube 34. The bend stiffener 30 comprises a stiffener body 36 which embraces the cable 32 and limits the minimum radius of curvature it can adopt. In the present embodiment the stiffener body 36 is a unitary tubular component with a through-going bore receiving the cable 32. It is formed of a compliant but resilient material so that it can withstand repeated flexure and polyurethane is the material selected in the present embodiment. The stiffener body 36 has a relatively broad root 38 and a relatively narrow and flexible tip 40, and a progressive taper from one to the other which in the illustrated example has a frusto-conical form. In this way its stiffness reduces from root to tip, and movement of the tip laterally is permitted in use whilst preventing excessively tight curvature of the cable 32 within the stiffener body, or excessive bending moments where it emerges from the stiffener body.

The root of the stiffener body 36 needs to be mounted in such a way that it is prevented from rotating through more than a small angle relative to the mouth of the I-tube 34, and in the illustrated embodiment this is achieved by rigidly coupling the stiffener body 36 to a connector tube 42, forming part of the bend stiffener itself, for receipt in the I-tube 34, which is of course part of the supporting structure and a separate item from the bend stiffener. In the illustrated embodiment, the connector tube 42 projects co-axially from the root of the stiffener body 36. Coupling between these two components is achieved by having the connector tube 42 project some distance into the root of the stiffener body 36, although this aspect cannot be seen in the drawings. The connector tube 42 must be sized for receipt in the I-tube 34 and will typically be specified to be a loose fit to allow the two parts to be engaged/disengaged even after corrosion and fouling have taken place in the marine environment. In the illustrated embodiment, the connector tube 42 engages with the interior of the I-tube 34 only through flanges or collars 44 at intervals along its length. In the illustrated example there are two such collars 44, widely spaced along the length of the connector tube 42. The connector tube 42 is not itself provided with any mechanical means for preventing axial movement relative to the I-tube.

Some means is needed for maintaining the connector tube 42 in engagement with the I-tube 34, and of course for bearing the weight of the entire bend stiffener. In accordance with the present invention, these functions are carried out by a float 46. By virtue of the float's displacement, the bend stiffener as a whole is positively buoyant and so when submerged is constantly upwardly biased. In this way the bend stiffener is maintained in engagement with the I-tube without need of any further mechanical coupling. As a result, mounting and de-mounting of the bend stiffener can be achieved in a particularly straightforward manner, as will be explained shortly. The float itself is formed in the illustrated embodiment by two semi-cylindrical shells assembled around the stiffener body 36 and secured to one another using circumferential tension straps 48, 50 located in respective circumferential troughs 52, 54 (FIG. 2). The assembled float is located relative to the stiffener body 36 by means of a locating flange 56, at the root end of the stiffener body 36, having a projecting peripheral lip 58 received in a complimentary undercut circular recess in the top of the float. It will be apparent that the two halves of the float 46 can be assembled around the flange 56 and subsequently retain it in position adjacent the upper end of the float.

The float 46 is in the present embodiment formed of moulded composite material more specifically syntactic foam—a combination of plastics resin such as epoxy with density reducing elements such as micro balloons or macro balloons. Syntactic foam is well known for use in such applications.

The cable 32 is to be suspended through a suspendable body 60. One way to de-couple the bend stiffener from the I-tube is simply to lower this body, so that it bears upon the upper end of the connector tube 42 and the weight thus applied to the bend stiffener overcomes its buoyancy and causes it to descend and so to disengage from the I-tube. Raising the suspendable body 60 reverses this process and re-couples the bend stiffener to the I-tube. Note that upward movement of the bend stiffener is limited by abutment of its locating flange 56 with a fixed flange 62 forming the lower end of the I-tube. In the drawings, this flange is seen to carry a second tube 64, but tins is redundant in the illustrated arrangement.

Numerous variations and modifications are possible without departing from the scope of the present invention as defined in the appended claims. For example, the bend stiffener has been described for use with, a cable 32 but could be applied to stiffening of any of a wide range of different types of underwater member including—for example and without limitation—risers used for sub sea drilling or for extraction of hydro carbons. Also the illustrated example is for use with an I-tube having a flange at its lower end, and for compatibility with this it uses a projecting connector tube 42. However if the I-tube were not flanged, the connector tube 42 could be replaced by a bore in the root end of stiffener body 36, to receive the I-tube internally.

What is claimed:

1. A bend stiffener for resisting excessive bending of an elongate underwater member in a region where it meets a supporting structure, the bend stiffener comprising a stiffener body defining a through-going channel for receiving and embracing the elongate member, and a connection part shaped and positioned to enable it to be engaged with a complementary feature of the supporting structure by upward movement of the bend stiffener to locate the stiffener body laterally and angularly, the bend stiffener being positively buoyant so that once the connection part is engaged with the supporting structure, the bend stiffener's buoyancy suffices to maintain it in engagement.

2. A bend stiffener as claimed in claim 1 comprising a connection part formed as a projecting elongate member for receipt by an upright I tube.

3. A bend stiffener as claimed in claim 1 comprising at least one float attached to the stiffener body to render the bend stiffener as a whole positively buoyant.

4. A bend stiffener as claimed in claim 3 in which the or each float is secured to the stiffener body through at least one tension band.

5. A bend stiffener as claimed in claim 4 comprising at least two floats assembled to one another around the stiffener body.

6. A bend stiffener as claimed in claim 1 in which the stiffener body has a relatively broad root end coupled to the connection member and a narrower and more flexible portion beneath the root end.

7. A bend stiffener as claimed in claim 1 having no mechanical means for restraining downward movement of the bend stiffener relative to the supporting structure.

8. A bend stiffener as claimed in claim 1 in which the connection part is a socket.
